(19) United States
(12) Patent Application Publication
(10) Pub. No.: US 2010/0236206 A1
(43) Pub. Date: Sep. 23, 2010

(54) Manufacturing Process for a Filter Element and a Filter Element

(75) Inventors: Susanne Klupski, (US); Jochen Linhart, Schwaikheim (DE); Josef Rohrmeier, Laberweinting (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/727,317

(22) Filed: Mar. 19, 2010

(30) Foreign Application Priority Data
Mar. 19, 2009 (DE) 102009013528.6-27

(51) Int. Cl. B01D 29/07; B32B 38/08; B32B 38/00

(52) U.S. Cl. 55/521; 156/292; 156/184; 156/89.11

(57) ABSTRACT

In a method for manufacturing a filter element of layers of a flat material and a corrugated material resting against one another, wherein the corrugated material has peaks and valleys, an adhesive is applied onto the flat material or the peaks of the corrugated material in a direction substantially parallel to the peaks of the corrugated material to be glued onto the flat material. The peaks of the corrugated material are then glued onto the flat material. A filter element is thus produced of layers of a flat material and a corrugated material resting against one another, wherein the corrugated material has peaks and valleys, wherein the peaks of the corrugated material are glued onto the flat material by adhesive strips that extend substantially parallel to the peaks.

### BACKGROUND OF THE INVENTION

The present invention concerns a manufacturing method for a filter element that comprises in particular several layers of corrugated material and flat material.

Filter elements are known that are comprised of composites of flow passages that are strung together. In this connection, corrugated and flat filter papers, for example, are glued together and then wound in order to provide a compact filter element. At the end faces the passages are then alternatingly closed off so that no direct flow through the passages formed between the filter papers is possible. DE 10 2006 025 235 A1 discloses, for example, such wound filter elements.

As disclosed in DE 10 2006 056 195 A1, similar wound structures are used also in connection with the manufacture of ceramic filter bodies. A wound material is immersed in a ceramic liquid that is subsequently fired.

In all of these wound and multi-layer elements a fixation of the layers relative to one another is generally realized by adhesives that are either applied so as to completely cover the surface area of the individual layers or are applied in beads so as to extend perpendicularly to the passages, for example, in the winding direction. Frequently, the required stability or strength cannot be achieved in this way. On the other hand, the adhesive closes off or clogs otherwise available filter surface area so that the efficiency of the filter element is reduced.

Based on this, it is therefore an object of the present invention to provide an improved method for manufacturing filter elements, in particular those with wound layers.

### SUMMARY OF THE INVENTION

In accordance with the present invention, this is achieved with a method of the aforementioned kind for producing a filter element that comprises contacting layers of a flat material and a corrugated material with peaks and valleys, wherein the peaks of the corrugated material are glued onto the flat material, such that the adhesive is applied onto the flat material or the peaks of the corrugated material in a direction parallel to the peaks of the corrugated material that is to be glued onto the flat material.

On the one hand, by applying the adhesive parallel to the peaks of the corrugated material, the applied adhesive on the flat material closes off or clogs the filter material, for example, only strip-wise. Despite of this, an especially great stiffness results because of the fixation of practically all peaks and valleys that are resting against flat material sections. It is, for example, possible to apply the adhesive in strips or beads onto the flat material and, subsequently, to press on the peaks along the resulting adhesive strips. In regard to the combination of flat material and glued-on material, the term semi-finished product is used.

In a variant of the method, such a semi-finished product that comprises the flat and the corrugated materials, is wound to a coil wherein the adhesive is applied substantially perpendicular to the winding direction. For example, it is conceivable to define a winding axis about which the semi-finished product is wound. While conventionally the adhesive is applied onto the flat material or the corrugated material perpendicularly to this winding axis, in the method according to the present invention the adhesive is applied parallel to this winding axis and thus perpendicularly to the winding direction. In this way, it is possible to afix the peaks of the corrugated material for example by means of beads or strips of glue that is water-based or solvent-based.

Preferably, the adhesive is applied exclusively parallel to the peaks of the corrugated material. In this way, it is prevented that upon use of glue threads that, for example, extend perpendicularly to the peaks or intercept the peaks, the filter surface area is reduced.

In a variant of the method according to the invention, the adhesive is printed by a printing method, in particular, by screen printing or offset printing, onto the flat material. By means of a drum or other printing media, for example, a strip-shaped pattern can be printed onto the flat material and, subsequently, winding can be carried out such that the glue strips or beads are pressed precisely onto the peaks of the corrugated material. As an adhesive, for example, a hot melt or powder is also possible that upon heating develops its adhesive properties. Preferably, adhesives are used that are printable.

According to another variant, it is moreover possible to apply the adhesive by means of a roller. For example, a roller can be pressed onto the corrugated material so that only the peaks of the corrugated material are partially coated with adhesive.

The flat material or the corrugated material comprises preferably a nonwoven material, for example, a cellulose material.

In expanding on the method of the present invention, the filter element can be employed for producing a particle filter, for example, for use in connection with diesel exhaust. In this connection, the filter element is immersed in or impregnated with a ceramic liquid, for example, a dispersion or suspension of ceramic particles, and subsequently dried. Upon sintering or firing the resulting ceramic, the respective (filter) material which serves as a matrix for the ceramic dispersion particles, can be burned off so that a ceramic filter body remains.

Moreover, the present invention is directed to a filter element that comprises layers of flat material and corrugated material resting against one another wherein the corrugated material comprise peaks and valleys and wherein the peaks of the corrugated material are glued onto the flat material by means of adhesive strips or beads that extend substantially parallel to the peaks of the corrugated material.

The term substantially parallel in this connection is to be understood such that, when the peaks are applied onto the flat material, along the respective contact surface between the peak and the flat material, respectively, a preferably continuous (contiguous) adhesive strip or bead is present. The term substantially parallel means also that, between the strips of adhesive, material surfaces are present that are not coated or covered with adhesive.

The filter element can be embodied, for example, as a compact air filter. In this connection, because of the efficient and thorough adhesive connection between the corrugated material and the flat material a higher stability of the semi-finished product as well as of the wound filter element will result. Also, the risk of delamination, i.e., detachment of a corrugated layer from a flat layer is reduced. The improved adhesive connection also goes hand in hand with reduced flow losses of unfiltered air that, in conventional filters, can penetrate into neighboring passages. As a whole, the filter element that is produced according to the proposed method is also more stable.

Further advantageous embodiments and variants of the invention are the subject matter of the dependent claims and of the embodiments disclosed in the following detailed description.

### BRIEF DESCRIPTION OF THE DRAWING

The invention will be explained in the following in more detail with the aid of several embodiments with reference to the attached drawings.

FIGS. 1 to 3 illustrate the steps of the manufacturing method according to the present invention, wherein:

FIG. 1A shows a perspective view of a flat material and a corrugated material to be joined for producing a filter element;

FIG. 1B illustrates the application of adhesive onto the flat material;

FIG. 2A is a cross-sectional view of the two layers according to FIG. 1A;

FIG. 2B is a cross-sectional view of the two layers according to FIG. 1B;

FIG. 3 shows in cross-section the corrugated material glued to the flat material.

FIG. 4A is a perspective view illustrating the application of adhesive onto a flat material surface by printing.

FIG. 4B is a section view illustrating the application of adhesive onto the material as shown in FIG. 4B.

FIG. 5A is a perspective view illustrating an application of adhesive onto the peaks of corrugated material by a roller.

FIG. 5B is a section view illustrating the roller application of adhesive onto the peaks of the corrugated material as shown in FIG. 5A.

FIG. 6 is a cross-sectional illustration of a wound filter.

In the Figures the same elements or elements that are functioning the same, if not noted otherwise, are identified with identical reference numerals.

### DESCRIPTION OF THE PREFERRED EMBODIMENTS

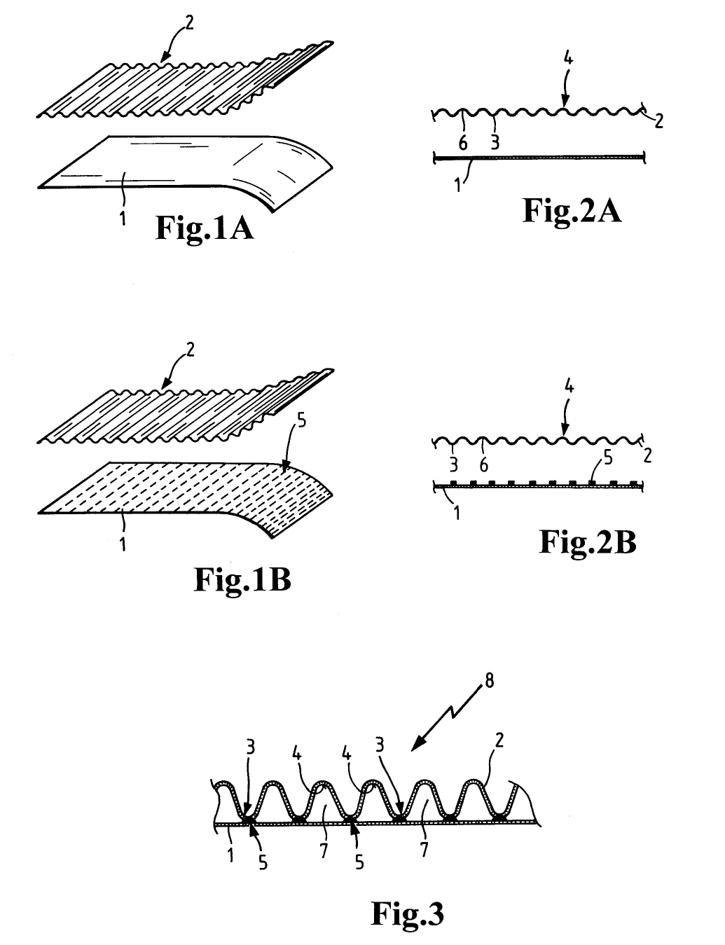

In FIGS. 1A, 1B components of a filter element to be produced according to the method of the present invention are shown in perspective view in different states. FIGS. 2A, 2B show the corresponding cross-sectional views during manufacture of a semi-finished product, for example, for use in compact air filters in the automotive field. In FIG. 1A a web-shaped flat layer or flat filter material 1 is illustrated. In order to produce a semi-finished product, a web 2 of corrugated filter material is provided. Similar to a corrugated cardboard material, the two material webs 1, 2 are joined with one another. In FIG. 2A the flat material 1 is illustrated as well as the corrugated material 2 that comprises peaks 3 and valleys 6. Relative to the flat material 1, for example, a peak 3 and a valley 6 are illustrated.

In the following, the term peak 3 is used to indicate in case of the corrugated filter material 2 that the side facing the flat material 1 of the corrugated sheet 2 has a projection. Usually, the corrugated material 2 has regular waves or folds. Accordingly, in case of a zigzag-fold material one can also speak of corrugated material. The waves in this case correspond to rounded fold edges.

In order to join the two material webs (the flat material 1 and the corrugated material 2) with one another, an adhesive is applied in strip-shape as indicated in FIG. 1B. FIG. 1B shows dashed lines 5 along which an adhesive strip or bead is applied onto the flat material 1. In the cross-sectional view of FIG. 2B, the adhesive strips 5 are indicated on the flat material 1; they are located opposite the peaks 3 of the corrugated material 2. It is then provided that the peaks 3 are pressed or pushed onto the adhesive strip 5 to secure them in this way. The peaks 4 that are facing away from the flat material 1 are of no concern in this context.

In FIG. 3, a semi-finished product 8 after completion of adhesive connection is illustrated in cross-section. The semi-finished product 8 comprises at least one flat surface of the material 1 onto which the adhesive strips 5 have been applied that, in turn, are in contact with the peaks 3 and therefore connect the corrugated material 2 with the flat material 1. In this way, a hollow space or cavity 7 between neighboring peaks 3 is provided, respectively, the peaks 3 being connected by the adhesive strips 5 on the flat material 1. Adjacent to a peak 3 there is a valley 4, respectively, within the cavity 7. The proposed manufacturing method provides thus by means of the adhesive strips 5 closed cavities or tubes to be entered by the fluid to be filtered.

While conventionally no adhesive connection of neighboring peaks on the flat material is realized, the adhesive prevents passage of the fluid between neighboring cavities. The filter action as well as the stability of a filter material made from such a semi-finished product 8 are therefore improved.

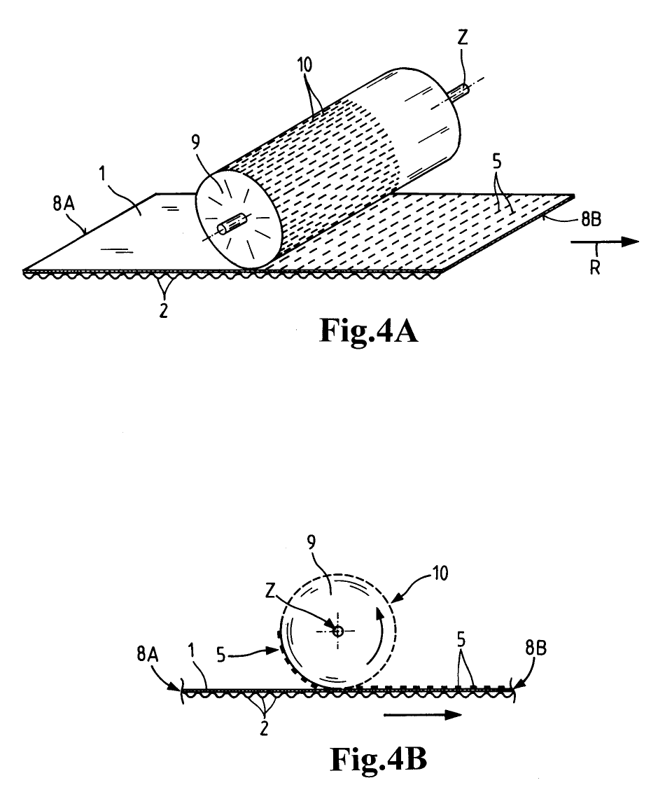

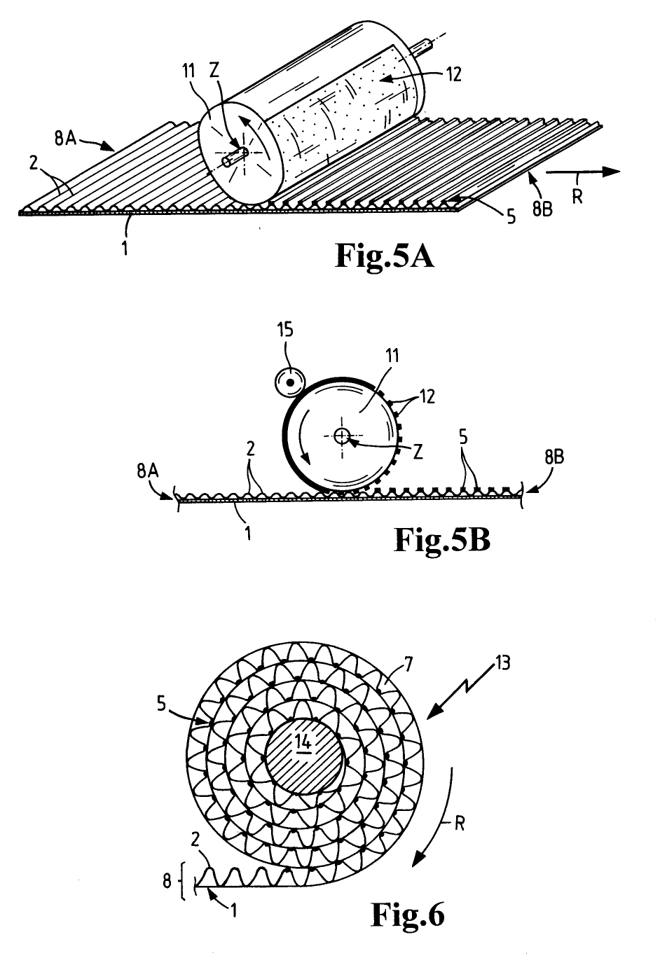

While FIGS. 1 to 3 generally show a strip-shaped adhesive applied parallel to the peaks, in FIGS. 4 and 5 exemplary printing methods for the application of the adhesive are illustrated. FIG. 4A illustrates in a perspective view how onto the flat face of a semi-finished product strip-shaped adhesive traces are printed. For this purpose, a print drum or roller 9 is provided that in the direction of its axis Z is provided on its surface with strip-shaped or slot-shaped openings 10 by means of which the adhesive can exit from the drum or roller and reach the drum or roller surface. The dashed lines indicate the area where the drum surface is coated with adhesive. For example, micrometer-sized holes in the drum surface can be provided for this purpose.

In FIG. 4B a corresponding cross-sectional view is shown in which the drum 9 on its surface has openings 10 through which the adhesive 5 may exit in order to be pressed or printed onto the flat surface of the flat material 1 of the semi-finished product. In this connection, the roller 9 conveys the semi-finished product of flat filter material 1 and corrugated filter material 2 in the conveying direction R as illustrated in FIG. 4A. In FIG. 4A the semi-finished product is also conveyed from the left to the right by means of the roller.

On the surface of the semi-finished product 8A illustrated to the left, i.e., before passing the drum 9, the surface of the web of flat material 1 is clean. On the right side, after having passed the roller, adhesive strips 5 have been printed on the surface of the flat material 1. This can be realized in accordance with the principle of offset printing or screen printing. The semi-finished product 8B has therefore adhesive 5 applied in a strip shape. In the cross-sectional view of FIG. 4B this is also illustrated: the adhesive strip 5 is printed onto the flat filter material 1 on the right side while on the left side it is still adhering to the roller 9.

It is subsequently possible to roll the semi-finished product about an axis as illustrated in an exemplary fashion in FIG. 6. In FIG. 6 the semi-finished product 8, that, for example, has been printed with adhesive strips by means of the print roller as illustrated in FIG. 4A, 4B, has been wound about an axis or a body 14. The winding direction R is indicated. FIG. 6 represents in principle a cross-section or a plan view of the end face of a wound filter element 13.

In FIG. 5 an alternative application of adhesive is illustrated in which the adhesive is coated onto the peaks. In FIG. 5A, a perspective view is shown in which a roller 11 is coated with adhesive 12. This roller is rolled across the corrugated material 2 of the semi-finished product 8. Accordingly, on each one of the peaks or crests an adhesive strip 5 will remain. The adhesive can be coated onto the roller surface by means of distribution by a second roller 15.

FIG. 5B shows in cross-section how the corrugated surface 2 of the semi-finished product 8 is conveyed by the roller or drum 11 coated with adhesive 12. On the right side the peaks that are coated with adhesive strips 5 are shown. Subsequently, as already explained in connection with FIG. 6, a wound filter can be produced wherein the peaks that are coated with adhesive or the flat material that has adhesive printed thereon are wound about axis 14. This is illustrated schematically in FIG. 6.

A corresponding filter element 13 results upon winding in a winding direction R, for example, about an inner body 14. By alternatingly closing the cavities 7 at one end face a plurality of flow passages for a fluid to be filtered are provided, for example, air in case of a compact air filter or exhaust gas particle filter, for example, diesel exhaust filter.

The manufacturing method can be expanded on in that a correspondingly wound filter element, as illustrated in FIG. 6, is impregnated with a dispersion of ceramic particles. As a material for the semi-finished product or the flat material or the corrugated material, cellulose is particularly suitable. After drying, the cellulose acts as a matrix for the ceramic. Upon subsequent sintering or firing of the filter element impregnated with ceramic liquid the cellulose can burn off so that no residues remain. In this way, a filter body of ceramic material, for example, for use as a diesel or soot particle filter is provided.

In comparison to conventional manufacturing methods and filter elements, the parallel adhesive application onto the peaks of the corrugated material has the advantage that neighboring flow passages are not only separated from one another by frictional adherence but also by the adhesive material. By means of the strip-wise application of the adhesive only a minimal surface area of the filter material is consumed so that the filter surface area as a whole remains large. As a whole, such filter elements are more stable than those of the prior art.

While specific embodiments of the invention have been shown and described in detail to illustrate the inventive principles, it will be understood that the invention may be embodied otherwise without departing from such principles.

What is claimed is:

1. A method for manufacturing a filter element that comprises layers of a flat material and a corrugated material resting against one another, wherein the corrugated material has peaks and valleys, the method comprising the steps of:
applying an adhesive onto the flat material or the peaks of the corrugated material in a direction substantially parallel to the peaks of the corrugated material to be glued onto the flat material;
gluing the peaks of the corrugated material onto the flat material.

2. The method according to claim 1, wherein in the step of applying the adhesive is applied in strips onto the flat material.

3. The method according to claim 1, wherein in the step of applying the adhesive is applied exclusively parallel to the peaks of the corrugated material.

4. The method according to claim 1, wherein in the step of applying a printing process is employed for applying the adhesive onto the flat material.

5. The method according to claim 4, wherein the printing process is screen printing.

6. The method according to claim 4, wherein the printing process is offset printing.

7. The method according to claim 1, wherein in the step of applying the adhesive is applied by a roller.

8. The method according to claim 1, wherein the flat material and the corrugated material form a semi-finished product, wherein the semi-finished product is wound in a winding direction to a coil and wherein the adhesive is applied substantially perpendicularly to a winding direction.

9. The method according to claim 1, wherein at least one of the flat material and the corrugated material is a nonwoven material.

10. The method according to claim 9, wherein the nonwoven material is cellulose material.

11. The method according to claim 1, comprising the step of impregnating the glued-together flat and corrugated materials with a ceramic liquid and subsequently firing the impregnated glued-together flat and corrugated materials for producing a particle filter.

12. A filter element comprising layers of a flat material and a corrugated material resting against one another, wherein said corrugated material comprises peaks and valleys, wherein said peaks of said corrugated material are glued onto said flat material by adhesive strips and wherein said adhesive strips extend substantially parallel to said peaks.

13. The filter element according to claim 12 in the form of a compact air filter.
